(19) United States
(12) Patent Application Publication
(10) Pub. No.: US 2007/0017500 A1
(43) Pub. Date: Jan. 25, 2007

(54) Barbecue cooker with an adjustable split grill assembly

(76) Inventor: Shang-Chih Chen, Taichung (TW)

Correspondence Address: HERSHKOVITZ & ASSOCIATES, 2845 DUKE STREET, ALEXANDRIA, VA, 22314, US

(21) Appl. No.: 11/187,995

(22) Filed: Jul. 25, 2005

(51) Int. Cl. F24B 3/00; A47J 37/00

(52) U.S. Cl. 126/25 R

(57) ABSTRACT

A barbecue cooker has a stand, a body and a grill assembly. The stand has a top. The body is attached to the top of the stand. The grill assembly is adjustably mounted on the body and has at least one column and at least two grids. The at least one column is adjustably mounted the body. The grids are adjustably mounted respectively on the at least one column. Accordingly, the grids can be individually rotated away from the body to different positions, and the use of the barbecue cooker is convenient and versatile.

### BACKGROUND OF THE INVENTION

1. Field of the Invention

The present invention relates to a barbecue cooker, and more particularly to a barbecue cooker with a grill assembly to make the barbecue cooker versatile and convenient in use.

2. Description of Related Art

A conventional barbecue cooker used to roast or toast food substantially comprises a stand, a body, a heat generator and a grill. The heat generator, such as a gas supply or charcoal fire is mounted on the body for generating heat. The grill is separately mounted on the body to support food to be roasted by the heat generated by the heat generator.

However, the conventional barbecue cooker has only one grill that is not adjustable and not moveable, so the conventional barbecue cooker is inconvenient and not versatile in use.

To overcome the shortcomings, the present invention tends to provide a barbecue cooker with an adjustable and split grill assembly to mitigate or obviate the aforementioned problems.

### SUMMARY OF THE INVENTION

The main objective of the invention is to provide a barbecue cooker that has an adjustable and split grill assembly and is convenient and versatile in use. The barbecue cooker has a stand, a body and a grill assembly. The stand has a top. The body is attached to the top of the stand. The grill assembly is adjustably mounted on the body and has at least one column and at least two grids. The at least one column is adjustably mounted on the body. The grids are adjustably mounted respectively on the at least one column.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a barbecue cooker in accordance with the present invention;

FIG. 2 is an exploded perspective view of the barbecue cooker in FIG. 1;

FIG. 3 is a partially cross sectional side plan view of the barbecue cooker in FIG. 1;

FIG. 4 is an operational top view of the barbecue cooker in FIG. 1 showing that the grids are adjusted to different positions; and

FIG. 5 is a side plan view of a second embodiment of a barbecue cooker in accordance with the present invention.

### DETAILED DESCRIPTION OF PREFERRED EMBODIMENT

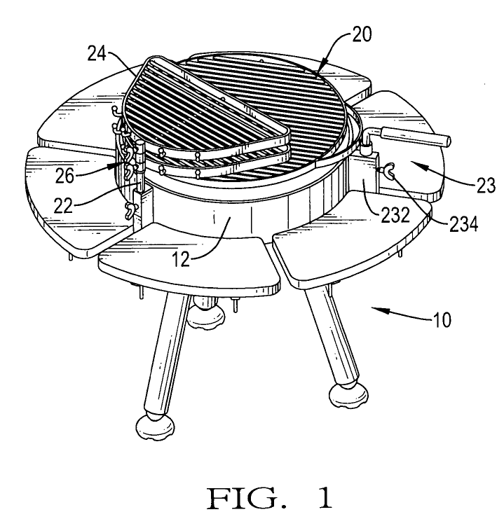

With reference to FIGS. 1, 2 and 5, a barbecue cooker in accordance with the present invention comprises a stand (10), a body (12) and a grill assembly (20). The stand (10) has a top. The body (12) is attached to and supported on the top of the stand (10). The structures of the stand (10) and the body (12) can be the same as conventional ones and are not further described.

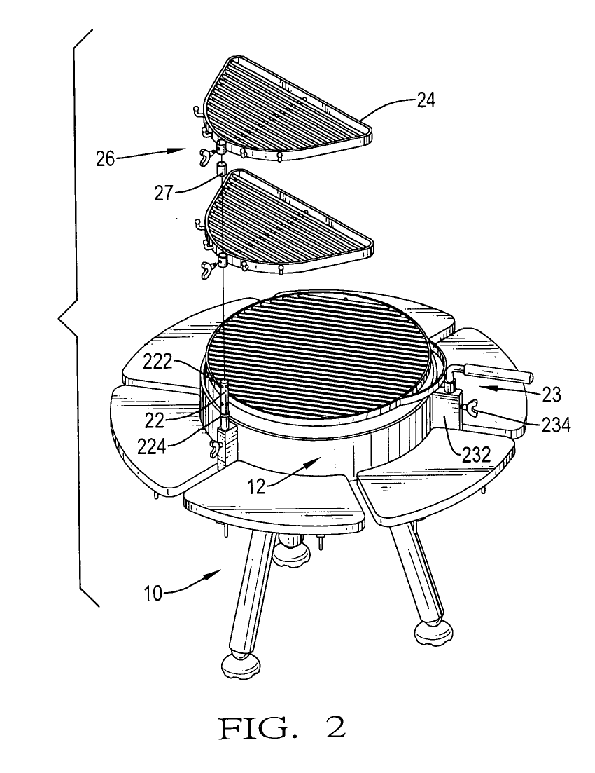

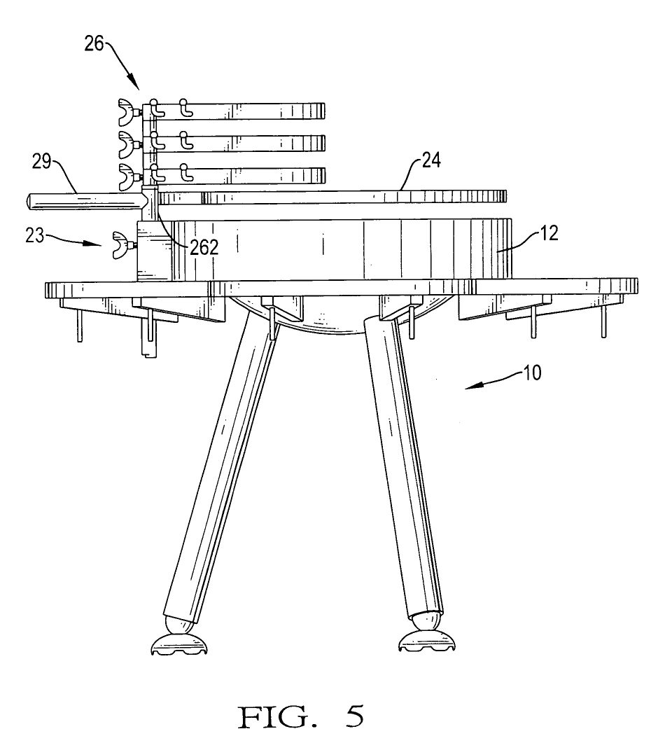

The grill assembly (20) is adjustably mounted on the body (12) and comprises at least one column (22) and multiple grids (24). In a first embodiment, the barbecue cooker has two columns (22) as shown in FIGS. 1 and 2. In a second embodiment, the barbecue cooker has a single column as shown in FIG. 5.

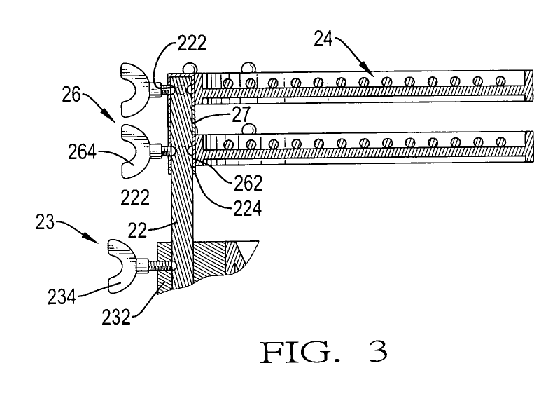

With further reference to FIG. 3, each column (22) is height-adjustably mounted on the body (12) via a respective one of a first positioning device (23). The first positioning device (23) comprises a block (232) and a holding screw (234). The block (232) is mounted on the body (12) and has a top and a hole defined in the top. Each column (22) is inserted into the hole in the corresponding block (232). The holding screw (234) is screwed into the block (232) and has a free end abutting against the column (22) to hold the column (22) in the block (232) at a desired height. When free end of the holding screw (234) is released from the column (22), the column (22) can be moved along the hole in the block (232). Accordingly, the height of the column (22) and the grids (24) on the column (22) is changed.

The grids (24) are respectively mounted on the at least one column (22), and each column (22) has at least one grid (24) mounted thereon. Each grid (24) is rotatably attached to the corresponding column (22) with a second positioning device (26). The second positioning device (26) comprises a sleeve (262) and a positioning screw (264). The sleeve (262) is securely attached to the grid (24) and is mounted around the column (22). The positioning screw (264) is screwed into the sleeve (262) and has a free end abutting with the column (22) to hold the grid on the column (22). In a preferred embodiment, each column has at least one positioning element formed in the column (22). Each positioning element has at least one positioning hole (222) and corresponds to the at least one grid (24) mounted on the column (22). The free end of the positioning screw (264) of each second positioning device (26) extends into the at least one positioning hole (222) of the corresponding positioning element in the column (22) to hold the grid (24) on the column (22) at a desired position.

Furthermore, a tubular spacer (27) is optionally mounted between each pair of adjacent grids (24) on a same column (22) to separate the grids (24). Each column (22) may further have a stop (224) formed around the column (22) to support the lowermost grid (24) on the column (22). With reference to FIG. 5, a handle (29) is optionally mounted on the sleeve (262) on one of the grids (24).

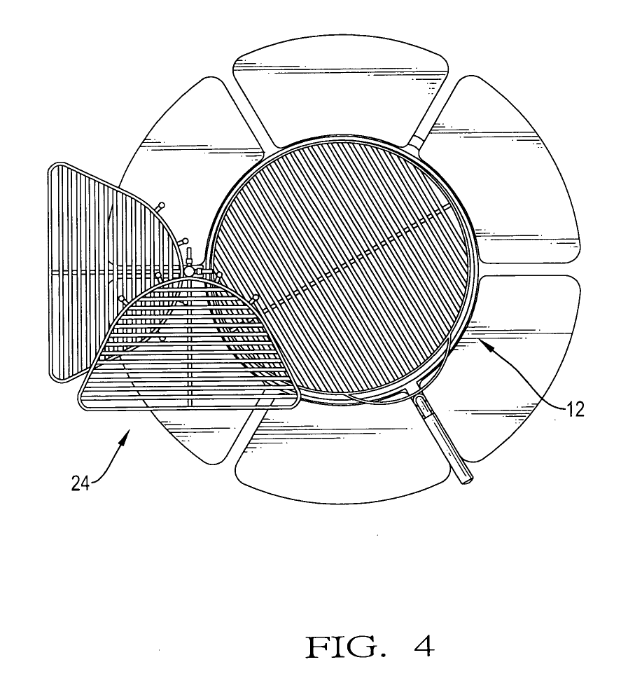

With such a barbecue cooker, with further reference to FIG. 4, the height of the grids (24) relative to the body (12) can be adjusted by means of releasing the holding screws (234) of the first positioning devices (23) and moving the columns (22) along the hole in the block (232).

After releasing the positioning screws (264) of the second positioning devices (26), the grids (24) can be individually rotated relative to the columns (22) and away from the body (12) to different positions. Consequently, the user can use these grids (24) for foods that require different cooking modes. For example, the user can put the already-barbecued food that needs to cool for a short time on a grid (24) entirely far away from the body (12), and can put already-barbecued food that needs to be kept warm on a grid (24) partially overlapped with the body (12). Furthermore, some food may need to be cooked close to the heat source while other food may need to be cooked quite high above the heat source and these modes are easily achieved by the present invention. Therefore, the use of the barbecue cooker is convenient and versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A barbecue cooker comprising:
a stand with a top;
a body attached to the top of the stand; and
a grill assembly adjustably mounted on the body,
wherein the grill assembly comprises
at least one column adjustably mounted on the body; and
at least two grids adjustably mounted respectively on the at least one column.

2. The barbecue cooker as claimed in claim 1, wherein
the grill assembly comprises two columns;
the grids are mounted respectively on the columns; and
each column has at least one grids mounted thereon.

3. The barbecue cooker as claimed in claim 2, wherein
a first positioning device mounted on the body, connected to each one of the at least one column to hold the column at a desired position and comprises
a block mounted on the body and having a top and a hole defined in the top and into which a corresponding column is inserted; and
a holding screw screwed into the block and having a free end abutting against the column to selectively hold the column in the block at a desired height.

4. The barbecue cooker as claimed in claim 3, wherein
each grid is rotatably attached to a corresponding column with a second positioning device that comprises
a sleeve attached to the grid and mounted around the corresponding column; and
a positioning screw screwed into the sleeve and having a free end abutting with the corresponding column to hold the grid on the corresponding column.

5. The barbecue cooker as claimed in claim 4, wherein
each column has at least one positioning element formed in the column, and each one of the at least one positioning element corresponds to one of the at least one grid mounted on the column and has at least one positioning hole; and
the free end of the positioning screw of each second positioning device extends into one of the at least one positioning hole of a corresponding one of the at least one positioning element in the corresponding column to selectively hold a corresponding grid on the corresponding column at a desired position.

6. The barbecue cooker as claimed in claim 5, wherein the grill assembly further comprises a tubular spacer mounted between each pair of adjacent grids mounted on a same column to separate the adjacent grids at different heights.

7. The barbecue cooker as claimed in claim 6, wherein each column further has a stop formed around the column to support a lowermost grid on the column.

8. The barbecue cooker as claimed in claim 1, wherein the grill assembly comprises a single column; and
all of the grids are mounted on the single column.

9. The barbecue cooker as claimed in claim 8, wherein
each grid is rotatably attached to the single column with a second positioning device that comprises
a sleeve attached to the grid and mounted around the column; and
a positioning screw screwed into the sleeve and having a free end abutting with the column to hold the grid on the single column.

10. The barbecue cooker as claimed in claim 9, wherein
the single column has multiple positioning elements formed in the single column, and each positioning element corresponds to one of the grids mounted on the single column and has at least one positioning hole; and
the free end of the positioning screw of each second positioning device extends into one of the at least one positioning hole of a corresponding positioning element in the single column to hold a corresponding grid on the single column at a desired position.

11. The barbecue cooker as claimed in claim 10, wherein the grill assembly further comprises a tubular spacer mounted between each pair of adjacent grids mounted on the single column to separate the adjacent grids at different heights.

12. The barbecue cooker as claimed in claim 11 further comprising a handle mounted on the sleeve on one of the grids.
